(19) United States
(12) Patent Application Publication
(10) Pub. No.: US 2012/0304145 A1
(43) Pub. Date: Nov. 29, 2012

(54) ELECTRONIC DEVICE AND WIRING METHOD FOR CIRCUIT BOARDS

(75) Inventors: YUNG-CHIEH CHEN, Tu-Cheng (TW); SHOU-KUO HSU, Tu-Cheng (TW); SHIN-TING YEN, Tu-Cheng (TW)

(73) Assignee: HON HAI PRECISION INDUSTRY CO., LTD., Tu-Cheng (TW)

(21) Appl. No.: 13/434,858

(22) Filed: Mar. 30, 2012

(30) Foreign Application Priority Data
May 26, 2011 (TW) 100118534

(51) Int. Cl. G06F 17/50

(52) U.S. Cl. 716/137

(57) ABSTRACT

An electronic device includes a wiring unit. The wiring unit creates one or more circuit diagrams for a design of a first circuit board, and setting electrical rules for components of the first circuit board in each of the one or more diagrams. Based on the one or more diagrams having the electrical rules, the wiring unit generates a wiring diagram for the design of the first circuit board by executing a wiring application. If a second circuit board desires to use a circuit diagram of the first circuit board, the wiring unit copies the circuit diagram having the electrical rules into the wiring application. Then, based on the copied circuit diagram having the electrical rules and particular circuit diagrams of the second circuit board, and the wiring unit creates a wiring diagram for the design of the second circuit board by executing the wiring application.

### BACKGROUND

1. Technical Field

The embodiments of the present disclosure relate to circuit design technology, and particularly to an electronic device and a method for wiring circuit boards.

2. Description of Related Art

Circuit diagrams are simplified conventional graphical representation of electrical circuits. The circuit diagrams do not show the physical arrangement of components on a designed device (e.g., a circuit board). A wiring diagram of the designed device is simplified conventional pictorial representation of the electrical circuits. The wiring diagrams show the components of the circuit diagrams as simplified shapes, and power and signal connections between the components. The wiring diagram usually gives more information about the relative position and arrangement of the components on the designed device, to help in building the designed device. The wiring diagram is often generated by loading the circuit diagrams into a wiring application, setting electrical rules in the wiring application, and then running a wiring function provided by the wiring application.

At present, if different circuit board designs include the same electric diagram, the same electric diagram is loaded into wiring applications (different designs may adopt the same or different wiring applications), and repetitively setting the same electrical rule as well as different electrical rules for creating wiring diagrams for the different designs. The more designs the same electric diagram is included, the more repetitive setting operations will be done.

### BRIEF DESCRIPTION OF THE DRAWINGS

FIG. 1 is one embodiment of a block diagram of an electronic device including a wiring unit.

FIG. 2 is one embodiment of function modules of the wiring unit in FIG. 1.

FIG. 3 is a flowchart of one embodiment of a wiring method for circuit boards.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

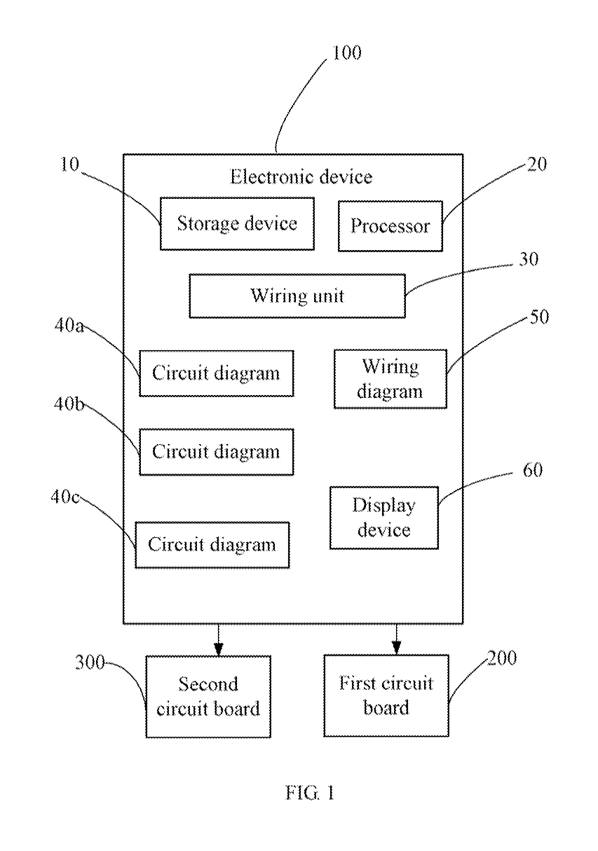

FIG. 1 is one embodiment of a block diagram of an electronic device 100. The electronic device 100 includes a storage device 10, a processor 20, a wiring unit 30, and a display device 60. The electronic device 100 may be a computer, a server, or other suitable electronic device that has data processing functions. The storage device 10 stores circuit diagrams and wiring diagrams of circuit boards having different designs. A circuit board may include one or more circuit diagrams illustrating different regions of the circuit board, and include one wiring diagram created according to the one or more diagrams. Different circuit boards may include the same circuit diagram while having different wiring diagrams. For example, the storage device 10 stores one or more circuit diagrams, such as circuit diagrams 40a, 40b, and 40c, and a wiring diagram 50 of a first circuit board 200. The storage device 10 may also store one or more circuit diagrams and a wiring diagram of a second circuit board 300. In this embodiment, the first circuit board 200 and the second circuit board 300 have the same circuit diagram, such as the circuit diagram 40a.

The wiring unit 30 creates the one or more circuit diagrams for the first circuit board 200, and setting electrical rules for components of the circuit board 200 in each of the one or more diagrams. Furthermore, and the wiring unit 30 generates the wiring diagram 50 for the circuit board 200 by executing a wiring application based on the one or more diagrams having the electrical rules. In response to the second circuit board 300 having the same circuit diagram (such as the circuit diagram 40a) as the first circuit board 200, the wiring unit 30 copies the same circuit diagram having the electrical rules into the wiring application, and creates a wiring diagram for the second circuit board 300 by executing the wiring application based on the copied circuit diagram having the electrical rules and particular circuit diagrams of the second circuit board 300. The display device 60 displays the one or more circuit diagrams and wiring diagrams.

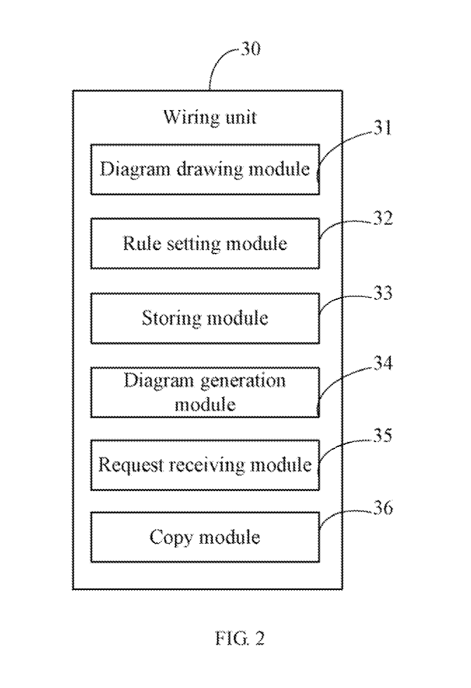

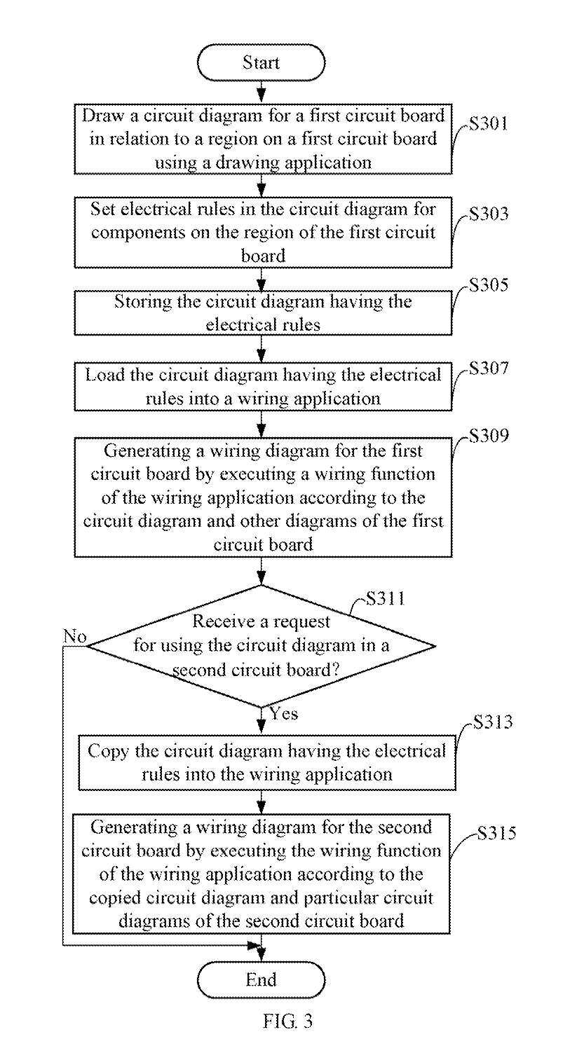

As shown in FIG. 2, the wiring unit 30 includes a diagram drawing module 31, a rule setting module 32, a storing module 33, a diagram generation module 34, a request receiving module 35, and a copy module 36. The modules 31-36 may include computerized code in the form of one or more programs that are stored in the storage device 10. The computerized code includes instructions to be processed by the processor 20 to provide the aforementioned functions of the wiring unit 30. A detailed description of the functions of the modules 31-36 are illustrated in FIG. 3. The storage device 10 may be a cache or a dedicated memory, such as an EPROM, HDD, or flash memory.

FIG. 3 is a flowchart of one embodiment of a wiring method for circuit boards. Depending on the embodiment, additional steps may be added, others removed, and the ordering of the steps may be changed.

In step S301, the diagram drawing module 31 draws a circuit diagram (such as the circuit diagram 40a) for the first circuit board 200 using a drawing application, such as Design Entry CIS. In this embodiment, the circuit diagram 40a is a partial circuit diagram in relation to a region (such as a CPU region) on the first circuit board 200. The diagram drawing module 31 also draws other circuit diagrams, such as the circuit diagrams 40b and 40c, in relation to other regions on the first circuit board.

In step S303, the rule setting module 32 sets electrical rules in the circuit diagram for components on the region of the first circuit board 200. In one embodiment, the electrical rules include design specifications of the components, circuit layers on which the components are located, line types, line spaces, and line lengths of transmission lines that connect the components. The design specifications of the components may include dimensions and materials of the components. The line types may include serpentine lines, differential lines, and right-angled lines. The first circuit board 200 may include multiple circuit layers, and the components in the same region may be arranged in different circuit layers. Similarly, the rule setting module 32 also sets electrical rules for other circuit diagrams (such as the circuit diagrams 40b and 40c) of the first circuit board 200 for components on other regions of the first circuit board 200.

In step S305, the storing module 33 stores the circuit diagram having the electrical rules into the storage device 10.

In step S307, the diagram generation module 34 loads the circuit diagram (such as the circuit diagram 40a) having the electrical rules of the first circuit board 200 into a wiring application, such as the printed circuit board (PCB) Editor. The diagram generation module 34 also loads other circuit diagrams (such as the circuit diagrams 40b and 40c) having other electrical rules of the first circuit board 200 into the wiring application.

In step S309, the diagram generation module 34 generates the wiring diagram 50 for the first circuit board 200 by executing a wiring function of the wiring application according to the circuit diagram (such as the circuit diagram 40a) and other diagrams (such as the circuit diagrams 40b and 40c) of the first circuit board 200.

In step S311, the request receiving module 35 determines if a request for using the circuit diagram (such as the circuit diagram 40a) has been received from the second circuit board 300. For example, the request receiving module 35 determines if a request of searching the circuit diagram 40a in the storage device 10 has been received. If no request for using the circuit diagram has been received, the procedure ends. Otherwise, if a request for using the circuit diagram has been received from the second circuit board 300, step S313 is implemented.

In step S313, the copy module 36 copies the circuit diagram (such as the circuit diagram 40a) having the electrical rules into the wiring application.

In step S315, the diagram generation module 34 generates a wiring diagram for the second circuit board 300 by executing the wiring function of the wiring application according to the copied circuit diagram and particular circuit diagrams of the second circuit board 300.

The above embodiments prefers to set electrical rules of a circuit board in circuit diagrams of the circuit board rather than setting electrical rules in the wiring process. Therefore, when other circuit board has the same circuit diagram, users can just copy the same circuit diagram for use, repetitive setting of the same electrical rules for the same circuit diagram is avoided.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented wiring method for circuit boards being performed by execution of instructions by a processor of an electronic device, the method comprising:
drawing one or more circuit diagrams for a design of a first circuit board using a drawing application, and setting electrical rules in each of the one or more circuit diagrams for components on the first circuit board;
storing the one or more diagrams having the electrical rules into a storage device of the electronic device;
loading the one or more circuit diagrams having the electrical rules into a wiring application; and
generating a wiring diagram for the design of the first circuit board by executing a wiring function of the wiring application according to the one or more circuit diagrams having the electrical rules.

2. The method of claim 1, further comprising:
copying a circuit diagram having corresponding electrical rules into the wiring application in response to receiving a request for using the circuit diagram in a design of a second circuit board; and
generating a wiring diagram for the design of the second circuit board by executing the wiring function of the wiring application according to the copied circuit diagram having the corresponding electrical rules and particular circuit diagrams of the design of the second circuit board.

3. The method of claim 1, wherein the electrical rules comprise design specifications of the components, circuit layers on which the components are located, line types, line spaces, and line lengths of transmission lines that connect the components.

4. The method of claim 3, wherein the design specifications comprise dimensions and materials of the components, and the line types comprise serpentine lines, differential lines, and right-angled lines.

5. A non-transitory medium storing a set of instructions, the set of instructions capable of being executed by a processor of an electronic device to perform a wiring method for circuit boards, the method comprising:
drawing one or more circuit diagrams for a design of a first circuit board using a drawing application, and setting electrical rules in each of the one or more circuit diagrams for components on the first circuit board;
storing the one or more diagrams having the electrical rules into a storage device of the electronic device;
loading the one or more circuit diagrams having the electrical rules into a wiring application; and
generating a wiring diagram for the design of the first circuit board by executing a wiring function of the wiring application according to the one or more circuit diagrams having the electrical rules.

6. The medium of claim 5, wherein the method further comprises:
copying a circuit diagram having corresponding electrical rules into the wiring application in response to receiving a request for using the circuit diagram in a design of a second circuit board; and
generating a wiring diagram for the design of the second circuit board by executing the wiring function of the wiring application according to the copied circuit diagram having the corresponding electrical rules and particular circuit diagrams of the design of the second circuit board.

7. The medium of claim 5, wherein the electrical rules comprise design specifications of the components, circuit layers on which the components are located, line types, line spaces, and line lengths of transmission lines that connect the components.

8. The medium of claim 7, wherein the design specifications comprise dimensions and materials of the components, and the line types comprise serpentine lines, differential lines, and right-angled lines.

9. An electronic device, comprising:
a storage device;
a processor; and
one or more programs stored in the storage device and being executable by the processor, the one or more programs comprising:
a diagram drawing module operable to draw one or more circuit diagrams for a design of a first circuit board using a drawing application, and set electrical rules in each of the one or more circuit diagrams for components on the first circuit board;
a storing module operable to store the one or more diagrams having the electrical rules into a storage device of the electronic device; and
a diagram generation module operable to load the one or more circuit diagrams having the electrical rules into a wiring application, and generate a wiring diagram for the design of the first circuit board design by executing a wiring function of the wiring application according to the one or more circuit diagrams having the electrical rules.

10. The electronic device of claim 9, wherein the one or more programs further comprise a copy module operable to copy a circuit diagram having corresponding electrical rules into the wiring application in response to receive a request for using the circuit diagram in a design of a second circuit board.

11. The electronic device of claim 10, wherein the diagram generation module is further operable to generate a wiring diagram for the design of the second circuit board by executing the wiring function of the wiring application according to the copied circuit diagram having the corresponding electrical rules and particular circuit diagrams of the design of the second circuit board.

12. The electronic device of claim 9, wherein the electrical rules comprise design specifications of the components, circuit layers on which the components are located, line types, line spaces, and line lengths of transmission lines that connect the components.

13. The electronic device of claim 12, wherein the design specifications comprise dimensions and materials of the components, and the line types comprise serpentine lines, differential lines, and right-angled lines.
